(19) United States
(12) Patent Application Publication
(10) Pub. No.: US 2009/0174643 A1
(43) Pub. Date: Jul. 9, 2009

(54) LIGHTING A CHOLESTERIC LIQUID CRYSTAL DISPLAY APPARATUS

(76) Inventors: Amir Ben Shalom, Modiin (IL); Christopher John Hughes, Berks (GB)

Correspondence Address: Pearl Cohen Zedek Latzer, LLP, 1500 Broadway, 12th Floor, New York, NY, 10036, US

(21) Appl. No.: 12/301,659

(22) PCT Filed: May 18, 2007
(86) PCT No.: PCT/GB07/01824

§ 371 Date: Nov. 20, 2008

(30) Foreign Application Priority Data
May 25, 2006 (GB) 0610433.5

(51) Int. Cl. G09G 3/36

(52) U.S. Cl. 345/94; 345/102

(57) ABSTRACT

A display apparatus comprises a cholesteric liquid crystal display device having cells comprising a layer of cholesteric liquid crystal material and an electrode arrangement capable of providing independent driving of a plurality of pixels across the layer of cholesteric liquid crystal material. A drive circuit generates drive signals supplied to the pixels to drive them into states reflectances in accordance with an image signal. The drive signals may have a waveform shaped to drive the respective pixels into the homeotropic state and the planar state alternately within successive drive periods for respective periods of time which are varied to provide an average reflectance as perceived by a viewer in accordance with the image signal. A light source illuminates the display device and is supplied with power by a power circuit. The power circuit supplies either: a) DC power, or b) AC power at a supply frequency F_{S} in accordance with the equation |2F_{S}−F_{H}|≧F_{T} where F_{H} is the frequency at which the pixels are driven into the planar state. This reduces the perception of flicker in a displayed image and F_{T} is the flicker fusion threshold.

The present invention relates to a display apparatus, in particular a display apparatus including a cholesteric liquid crystal display device using the homeotropic state as the dark image state.

A cholesteric liquid crystal display device is a type of reflective display device having a low power consumption and a high brightness. A cholesteric liquid crystal display device uses one or more cells each having a layer of cholesteric liquid crystal material capable of being driven into a plurality of states. These states include a planar state being a stable state in which the layer of cholesteric liquid crystal material reflects light with wavelengths in a band corresponding to a predetermined colour. In another state, the cholesteric liquid crystal transmits light. A full colour display may be achieved by stacking layers of cholesteric liquid crystal material capable of reflecting red, blue and green light. For driving to display an image, the display device typically has an electrode arrangement capable of providing driving of a plurality of pixels across the layer of cholesteric liquid crystal material by respective drive signals.

Most development of cholesteric liquid crystal displays has concentrated on use of the stable states of the liquid crystal material, these being the planar state providing a high reflectance and the focal conic state providing a low reflectance, as well as range of mixture states providing intermediate reflectances as a result of the liquid crystal material having domains in each of the planar and focal conic states. In this case, the focal conic state is used as the dark image state. The use of stable states provides the advantage of low power consumption as energy is only needed to drive the change of state, whereafter the liquid crystal remains in a stable state displaying an image without consuming power. All current commercially available cholesteric liquid crystal display devices work in this mode of operation.

Due to its reflective nature, a cholesteric display device is particularly suitable for use outside. Bright illuminating light such as sunlight results in much light being reflected. Thus the cholesteric display device has a high brightness and a good contrast ratio is maintained. This contrasts with an emissive display device for which the contrast ratio is degraded under bright illuminating light. A cholesteric display device is suitable for many outdoor applications, notably as an electronic billboard for displaying advertising and other images, for example as disclosed in WO-01/88688.

However, if use of the display device is required in low light levels, it is necessary to illuminate the display device. For example, WO-01/88688 discloses that the display device has a light source in the form of four lamps mounted thereon.

Whilst use of the stable states provides a display device with a good contrast ratio, the contrast ratio is limited by the fact that the focal conic state scatters light and this has a reflectance of the order of 3-4%. It has been reported in J Y Nahm et al., Asia Display 1998 pp 979-982 and in WO-2004/030335 that a higher contrast ratio can be achieved by use of the homeotropic state of the cholesteric liquid crystal material which has a lower reflectance than the focal conic state. Thus use of the homeotropic state as the dark state instead of the focal conic state has the advantage of increasing the contrast ratio and improving the colour gamut.

The homeotropic state is an unstable state and thus requires the continuous application of power to maintain the state. This means that the display apparatus must have an electrode arrangement which is capable of providing driving of a plurality of pixels across the layer of cholesteric liquid crystal material independently by respective drive signals.

To achieve grey levels when using the homeotropic state, WO-2004/030335 discloses the use of temporal dithering. That is to say, the drive signals have a waveform shaped to drive the respective pixels into the homeotropic state and the planar state alternately within a drive period. As a result, the periods of time during which the pixel is driven into the homeotropic and planar states are sufficiently short that the reflectance perceived by the viewer is a time average of the reflectance of the pixel in each of the homeotropic and planar states. The duty period and hence respective periods of the homeotropic and planar states are varied in accordance with the image signal to vary the perceived reflectance and hence to provide grey levels.

The present invention is derived from an observation by the present inventors that when the pixels of a cholesteric display device are driven into the homeotropic state and the planar state alternately and simultaneously illumination is provided by an artificial light source and there can in some circumstances occur flickering of the image displayed on the display device. The present invention is concerned with reducing or eliminating this problem.

According to a first aspect of the present invention, there is provided display apparatus comprising:

a cholesteric liquid crystal display device having at least one cell comprising a layer of cholesteric liquid crystal material and an electrode arrangement capable of providing independent driving of a plurality of pixels across the layer of cholesteric liquid crystal material by respective drive signals to drive the pixels into states providing the pixels with respective reflectances;

a drive circuit arranged to generate drive signals to drive respective pixels into states providing the pixels with reflectances in accordance with an image signal, wherein in respect of at least part of a range of possible reflectances the drive signals have a waveform shaped to drive the respective pixels into the homeotropic state and the planar state alternately within successive drive periods for respective periods of time which are varied to provide an average reflectance as perceived by a viewer in accordance with the image signal,

a light source disposed to illuminate the display device when the light source is lit;

a power circuit connected to supply power to the light source, the power circuit being arranged to supply either:

a) DC power, or

b) AC power at a supply frequency F_{S} in accordance with the equation

|2F_{S}−F_{H}|≧F_{T}

where F_{H} is the frequency at which the pixels are driven into the planar state by the drive signals having a waveform shaped to drive the respective pixels into the homeotropic state and the planar state alternately, and F_{T} is the flicker fusion threshold.

The present invention provides reduction of the perception of flickering of the image displayed on the display device which occurs in some circumstances when the pixels of a cholesteric display device are driven into the homeotropic state and the planar state alternately whilst simultaneously illuminating the display device by a light source. The reduction of flicker is based on an appreciation that the flicker is caused by an interference effect between the illuminating light and the temporal dither of the homeotropic and planar states, as follows. The flicker occurs when the light source is supplied with AC power. In this case the illumination power of the light illuminating the display device fluctuates with the instantaneous power of the power supply which itself fluctuates at twice the supply frequency F_{S} because the instantaneous power is proportional to the square of the instantaneous voltage.

At the same time, when the pixels are driven alternately into the homeotropic state and the planar state, the pixels are alternately non-reflective and reflective. Illuminating light is only reflected while a given pixel is reflective and this causes an interference effect between the variation in the illuminating light and the variation in the reflectivity. Where the frequency F_{H} is less than the frequency 2F_{S} of the illuminating light, this may be thought of as the pixel sampling the illuminating light when the pixel is reflective. The interference effect causes a variation in the reflected light at the interference frequency of |2F_{S}−F_{H}|. This variation at the interference frequency |2F_{S}−F_{H}| is perceived by the viewer as flicker. For example, in one embodiment, the frequency F_{H} of driving the pixels into the planar state was 83 Az and the light source was a metal-halide discharge lamp supplied with AC power at a supply frequency F_{S} of 50 Hz. In this case, the variation in reflected light cause the image to be perceived to flicker at an interference frequency of 17 Hz.

The present invention reduces or eliminates this problem of flicker by careful selection of the power supplied to the light source, as follows.

In alternative (a), the supplied power is DC power. In this case, the illuminating light output by the light source is sufficiently constant that there is no variation perceived by the viewer in the light reflected by the pixels when in the reflective planar state. As a result, the image is not perceived to flicker.

In the case of alternative (a), the light source may comprise at least one light-emitting diode or an incandescent lamp, e.g. a halogen lamp.

In alternative (b), the interference frequency |2F_{S}−F_{H}| is arranged to be at or above the flicker fusion threshold F_{T} which may be taken to be 40 Hz, or to provide an improved effect 50 Hz or 100 Hz. In this case, variation in the magnitude of the reflected light does occur but at a frequency higher than flicker fusion threshold F_{T} such that perception of flicker by the viewer is reduced or removed altogether.

Advantageously, in alternative (b), the supply frequency F_{S} is in accordance with the equation

(2F_{S}−F_{H})≧F_{T}.

In this case, the supply frequency F_{S} is larger than the frequency F_{H} by at least F_{T}/2. Thus, this results in use of a relatively high supply frequency F_{S}, which in turn reduces the perception by the viewer of any variation in the illuminating light. Otherwise, such a variation in the illuminating light could itself be perceived by the viewer which would be distracting. Also, such variation in the illuminating light at a low frequency may cause variation in the reflected light if any part of the image is driven by a drive signal having a waveform shaped to drive the pixel into a stable state which is maintained until the displayed image changes. To avoid such effects altogether, the supply frequency F_{S} is at or above the flicker fusion threshold F_{T}.

In the context of a cholesteric liquid crystal display device where use is made of the homeotropic state, the perception of flicker may be further reduced by using a power circuit arranged to supply AC power having a waveform causing the magnitude of the variations in the illumination power of the light emitted by the light source to be reduced as compared to a sinusoidal waveform. For example, as the AC power may have a waveform shaped as a square wave. In this case, the instantaneous electrical power is constant for most of the cycle, dipping only as the polarity of the waveform changes. As compared to a sinusoidal waveform, this reduces the magnitude of the variations in the illumination power of the light emitted by the light source. This in turn reduces the magnitude of the variation in the light reflected by the pixels as part of the interference effect. Thus the use of a square wave further contributes to the reduction in the perception of flicker. In fact it has been appreciated that reducing the magnitude of the variation in illumination power allows use of a supply frequency F_{S} providing an interference frequence |2F_{S}−F_{H}| of lower frequencies without the perception of flicker by the user. In other words the reduction in the magnitude of the variation of the illumination power effectively lowers the flicker fusion threshold below which flicker is perceived.

In the case of alternative (b), the light source may comprise at least one discharge lamp, such as a metal-halide discharge lamp. In the case of a discharge lamp, the power circuit may comprise:

a power input for receiving an external AC power supply; and

an electronic ballast connected between the power input and the at least one discharge lamp, the electronic ballast being operable to convert the frequency of the external AC power supply received at the power input to provide said AC power at said supply frequency F_{S}.

To allow better understanding, a cholesteric liquid crystal display device which embodies the present invention will now be described by way of non-limitative example with reference to the accompanying drawings. In the drawings:

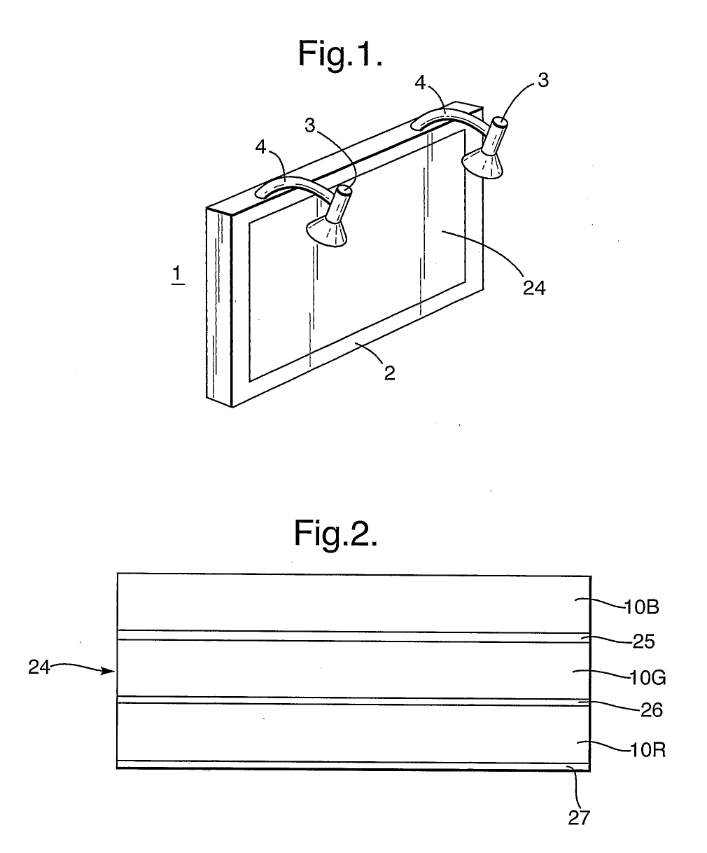

FIG. 1 is a perspective view of a cholesteric liquid crystal display device;

FIG. 2 is a cross-sectional view of the cholesteric liquid crystal display device;

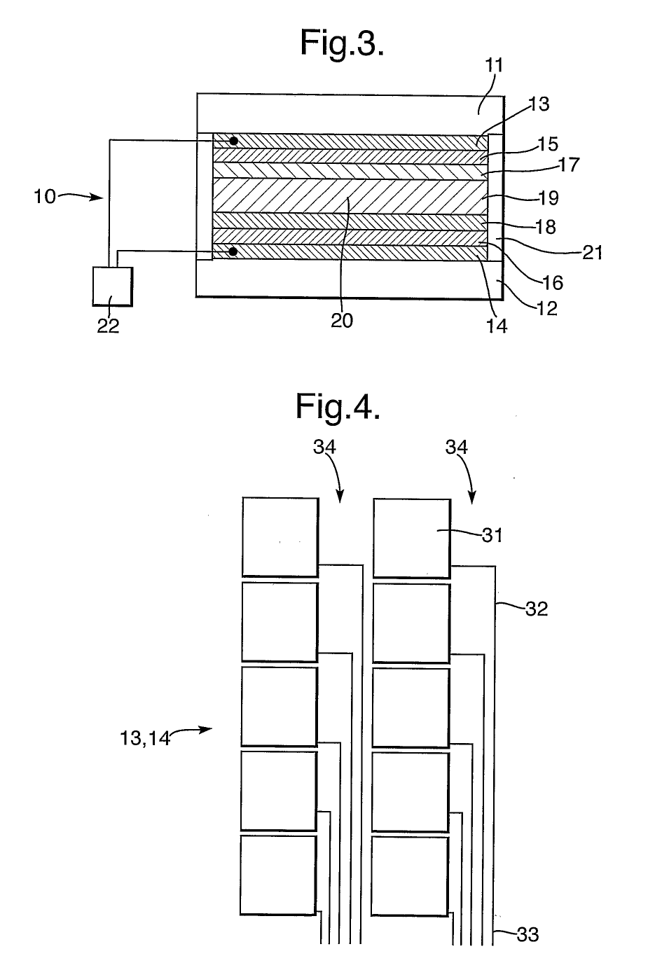

FIG. 3 is a cross-sectional view of a cell of a cholesteric liquid crystal display device;

FIG. 4 is a plan view of the electrode arrangement of a conductive layer of the cell of FIG. 3;

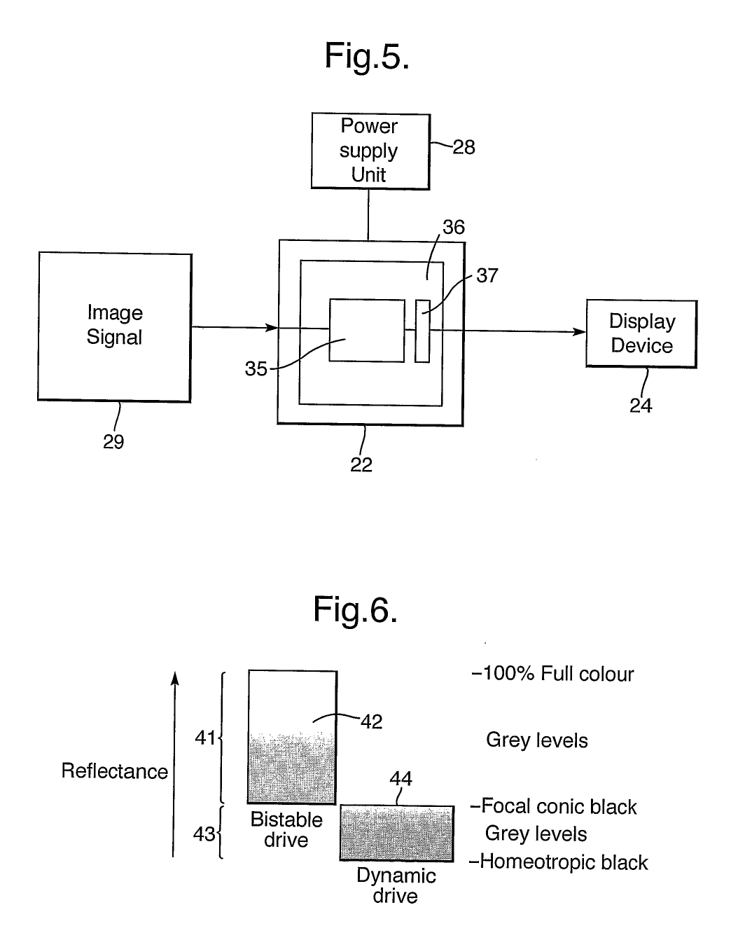

FIG. 5 is a diagram of the drive circuit of the display device;

FIG. 6 is a schematic diagram illustrating the drive schemes used to drive pixels to different reflectances;

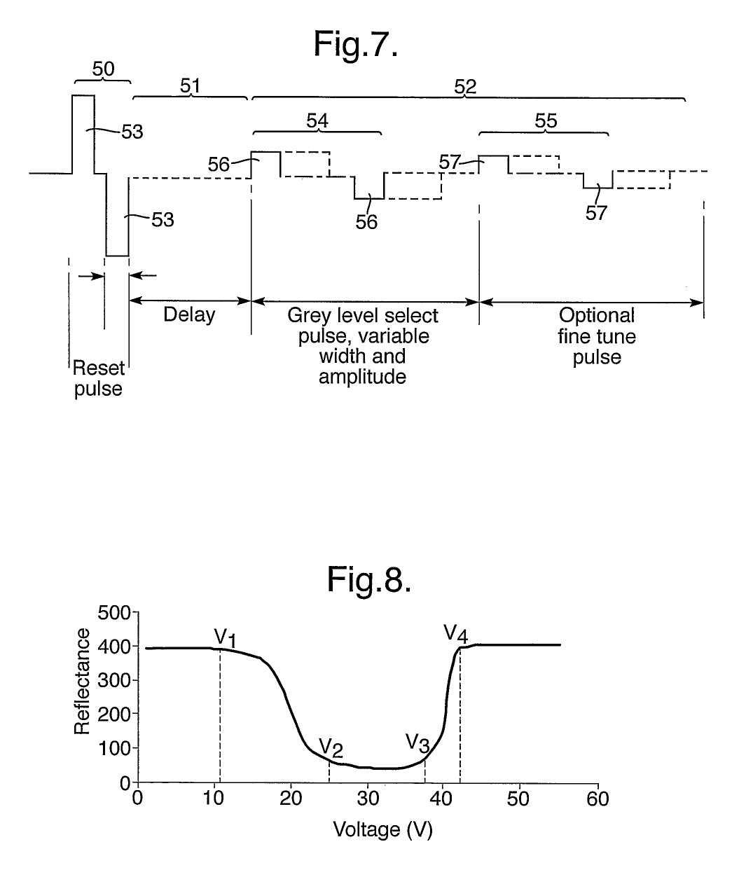

FIG. 7 is a graph of a drive signal in accordance with a static drive scheme;

FIG. 8 is a graph of the electro-optical curve of a typical liquid crystal material;

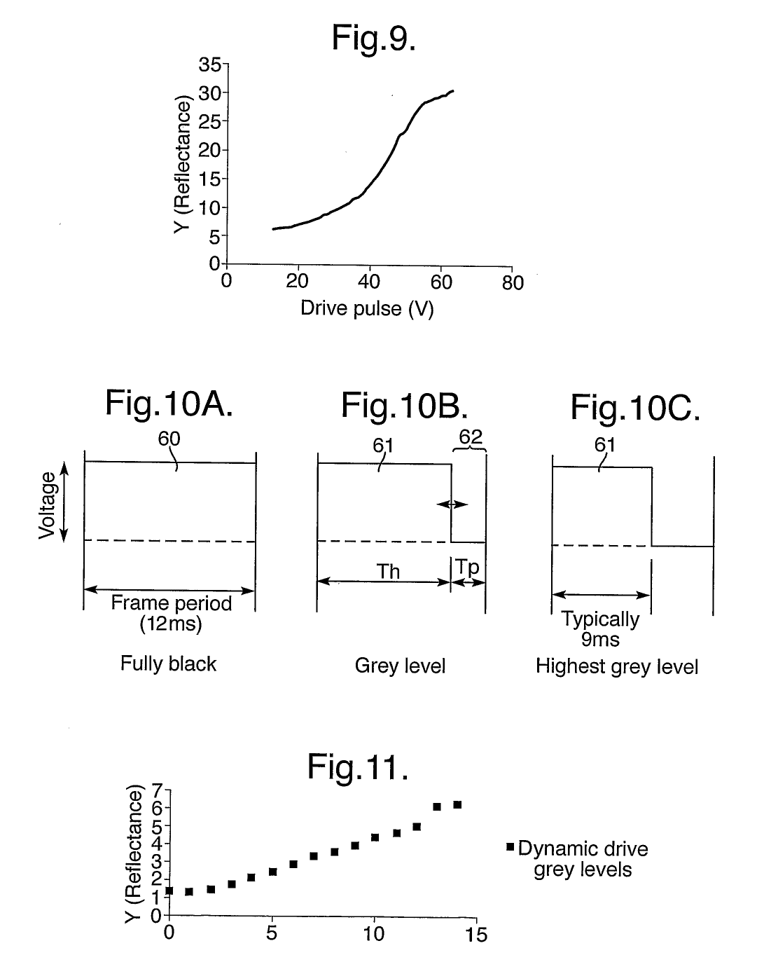

FIG. 9 is a graph of reflectance of the pixel against amplitude of a selection pulse with the drive signal of FIG. 7;

FIGS. 10A to 10C are graphs of a drive signal in accordance with a dynamic drive scheme;

FIG. 11 is a graph of the reflectance of a pixel against the period of the relaxation period with the drive signal of FIGS. 10A to 10C;

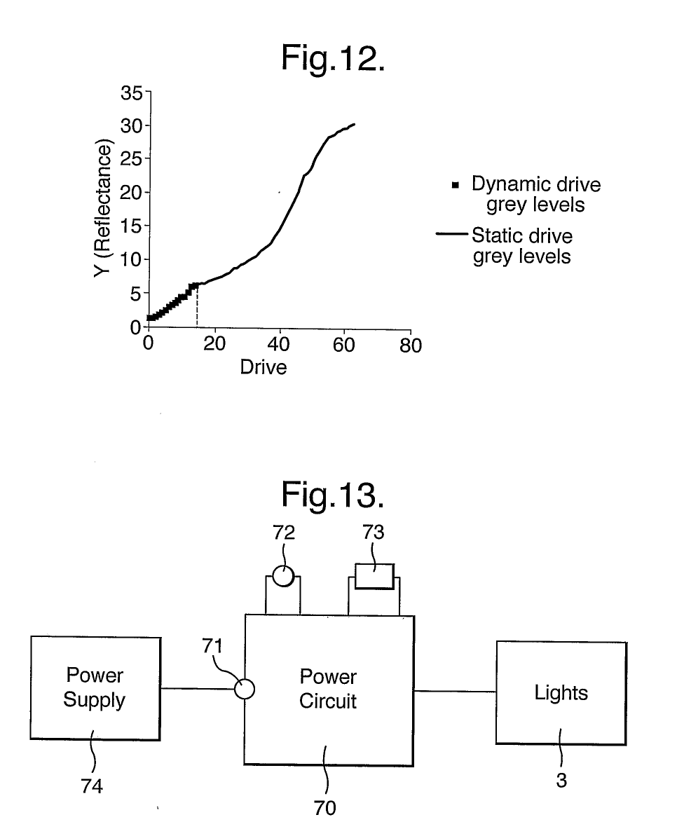

FIG. 12 shows the graphs of FIGS. 9 and 11 overlapping each other; and

FIG. 13 is a diagram of a power circuit of a lamp of the cholesteric liquid crystal display device;

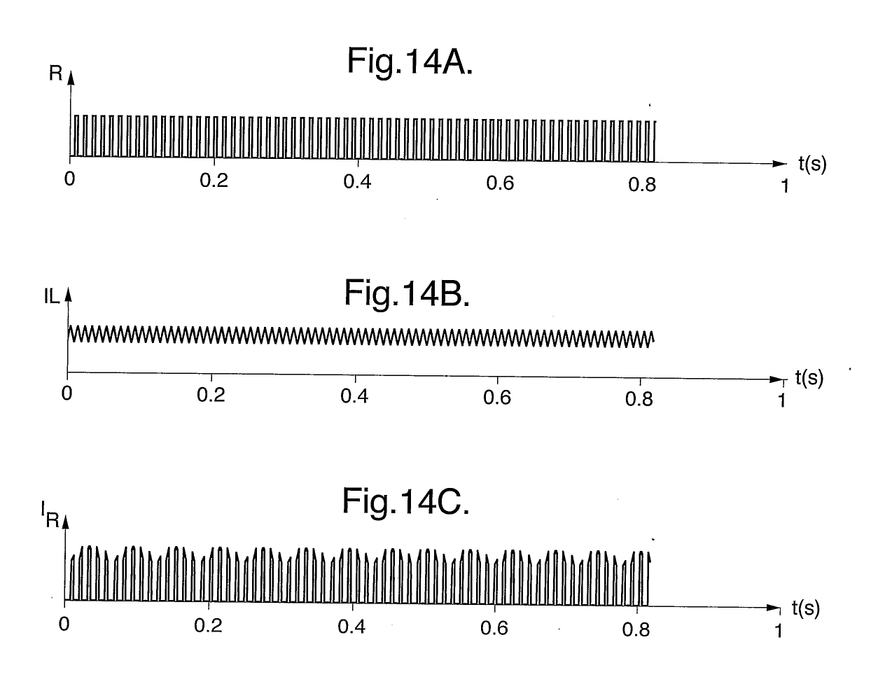

FIGS. 14A to 14C are graphs illustrating light reflected from the cholesteric liquid crystal display device illuminated by a metal-halide discharge lamp supplied with 50 Hz AC power;

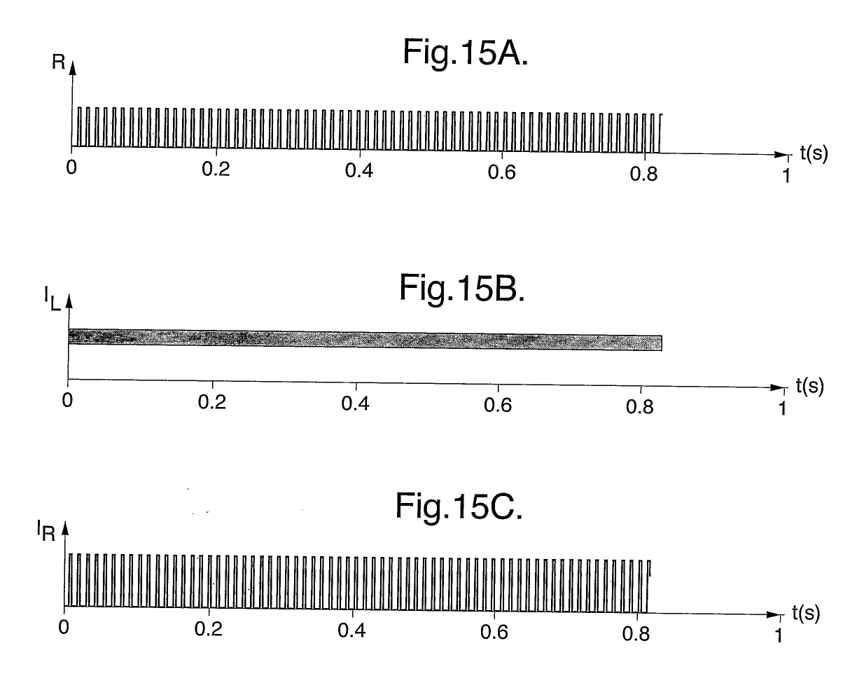

FIGS. 15A to 15C are graphs illustrating light reflected from the cholesteric liquid crystal display device illuminated by a metal-halide discharge lamp supplied with 500 Hz AC power; and

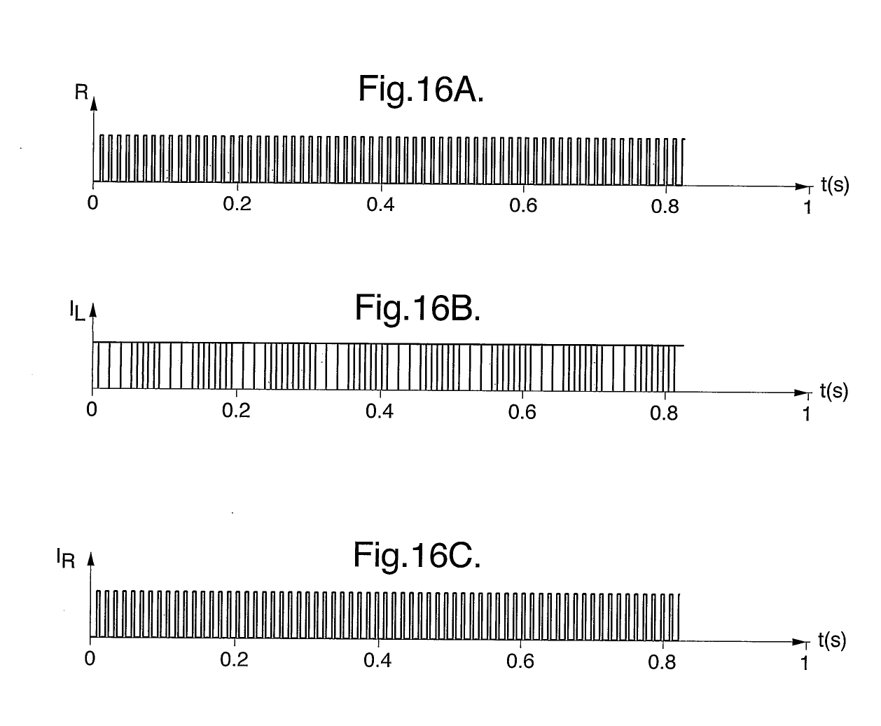

FIGS. 16A to 16C are graphs illustrating light reflected from the cholesteric liquid crystal display device illuminated by a metal-halide discharge lamp supplied with 65 Hz AC power having a square wave waveform.

As shown in FIG. 1, a display apparatus 1 comprises a cholesteric liquid crystal display device 24 mounted in a frame 2. A pair of lights 3 are supported on the frame 2 by respective arms 4. The lights 3 are directed to illuminate the display device 24 when lit and hence constitute a light source.

The cholesteric liquid crystal display device 24 will first be described in detail.

As shown in FIG. 2, the cholesteric liquid crystal display device 24 comprises three cells 10R, 10G, 10B each of which has the same construction as illustrated in FIG. 3 which shows a single cell 10.

The cell 10 has a layered construction, the thickness of the individual layers 11-19 being exaggerated in FIG. 3 for clarity.

The cell 10 comprises two rigid substrates 11 and 12, which may be made of glass or preferably plastic. The substrates 11 and 12 have, on their inner facing surfaces, respective transparent conductive layers 13 and 14 formed as a layer of transparent conductive material, typically indium tin oxide. The conductive layers 13 and 14 are patterned to provide a rectangular array of addressable pixels, as described in more detail below.

Optionally, both conductive layers 13 and 14 are overcoated with a respective insulation layer 15 and 16, for example of silicon dioxide, or possibly plural insulation layers.

The substrates 11 and 12 define between them a cavity 20, typically having a thickness of 3 μm to 10 μm. The cavity 20 contains a liquid crystal layer 19 and is sealed by a glue seal 21 provided around the perimeter of the cavity 20. Thus the liquid crystal layer 19 is arranged between the conductive layers 13 and 14.

Each substrate 11 and 12 is further provided with a respective alignment layer 17 and 18 formed adjacent the liquid crystal layer 19, covering the respective conductive layer 13 and 14, or the insulation layer 15 and 16 if provided. The alignment layers 17 and 18 align and stabilise the liquid crystal layer 19 and are typically made of polyimide which may optionally be unidirectionally rubbed. Thus, the liquid crystal layer 19 is surface-stabilised, although it could alternatively be bulk-stabilised, for example using a polymer or a silica particle matrix.

The liquid crystal layer 19 comprises cholesteric liquid crystal material. Such material has several states in which the reflectivity and transmissivity vary. These states are the planar state, the focal conic state and the homeotropic (pseudo nematic) state, as described in I. Sage, Liquid Crystals Applications and Uses, Editor B Bahadur, Vol. 3, 1992, World Scientific, pp 301-343 which is incorporated herein by reference and the teachings of which may be applied to the present invention.

In the planar state, the liquid crystal layer 19 selectively reflects a bandwidth of light that is incident upon it. The reflectance spectrum of the liquid crystal layer 19 in the planar state typically has a central band of wavelengths in which the reflectance of light is substantially constant.

The wavelength λ of the reflected light are given by Bragg's law, ie λ=nP, where n is the refractive index of the liquid crystal material seen by the light and P is the pitch length of the liquid crystal material. Thus in principle any colour can be reflected as a design choice by selection of the pitch length P. That being said, there are a number of further factors which determine the exact colour, as known to the skilled person. The planar state is used as the bright state of the liquid crystal layer 19.

Not all the incident light is reflected in the planar state. In a typical full colour display device 24 employing three cells 10, as described further below, the peak reflectivity is typically of the order of 40-45%. The light not reflected by the liquid crystal layer 19 is transmitted through the liquid crystal layer 19. The transmitted light is subsequently absorbed by a black layer 27 described in more detail below.

In the focal conic state, the liquid crystal layer 19 is, relative to the planar state, transmissive and transmits incident light. Strictly speaking, the liquid crystal layer 19 is mildly light scattering with a small reflectance, typically of the order of 3-4%. As light transmitted through the liquid crystal layer is absorbed by the black layer 27 described in more detail below, this state is perceived as darker than the planar state.

In the homeotropic state, the liquid crystal layer 19 is even more transmissive than in the focal conic state, typically having a reflectance of the order of 0.5-0.75%. Use of the homeotropic state as the dark state has the advantage of increasing the contrast ratio, as compared to use of the focal conic state as the dark state.

The display apparatus 1 has a drive circuit 22 mounted inside the housing 2. The drive circuit 22 supplies a drive signal to the conductive layers 13 and 14 which consequently apply the drive signal across the liquid crystal layer 19 to switch it between its different states. The drive circuit 22 is described in more detail below, but two general points are to be noted.

Firstly, the focal conic and planar states are stable states which can coexist when no drive signal is applied to the liquid crystal layer 19. Furthermore the liquid crystal layer 19 can exist in stable states in which different domains of the liquid crystal material are each in a respective one of the focal conic state and the planar state. These are sometimes referred to as mixture states. In these mixture states, the liquid crystal material has a reflectance intermediate the reflectances of the focal conic and planar states. A range of such stable states is possible with different mixtures of the amount of liquid crystal in each of the focal conic and planar states so that the overall reflectance of the liquid crystal material varies, thus giving a range of grey levels.

Secondly, the homeotropic state is not stable and so maintenance of the homeotropic state requires continued application of a drive signal.

As shown in FIG. 2, the display device 24 comprises the cells 10R, 10G and 10B arranged in a stack. The cells 10R, 10G and 10B have respective liquid crystal layers 19 which are arranged to reflect light with colours of red, green and blue, respectively. Thus the cells 10R, 10G and 10B will thus be referred to as the red cell 10R, the green cell 10G and the blue cell 10B. Selective use of the red cell 10R, the green cell 10G and the blue cell 10B allows the display of images in full colour, but in general a display device could be made with any number of cells 10, including one.

In FIG. 2, the front of the display device 24 from which side the viewer is positioned is uppermost and the rear of the display device 24 is lowermost. Thus, the order of the cells 10 from front to rear is the blue cell 10B, the green cell 10G and the red cell 10R. This order is preferred for the reasons disclosed in West and Bodnar, “Optimization of Stacks of Reflective Cholesteric Films for Full Color Displays”, Asia Display 1999 pp 20-32, although in principle any other order could be used.

The adjacent pair of cells 10R and 10G and the adjacent pair of cells 10G and 10B are each held together by respective adhesive layers 25 and 26.

The display device 24 has a black layer 27 disposed to the rear, in particular by being formed on a rear surface of the red cell 10R which is rearmost. The black layer 27 may be formed as a layer of black paint. In use, the black layer 27 absorbs any incident light which is not reflected by the cells 10R, 10G or 10B. Thus when all the cells 10R, 10G or 10B are switched into a transmissive state, the display device appears black.

The display device 24 is similar to the type of device disclosed in WO-01/88688 which is incorporated herein by reference and the teachings of which may be applied to the present invention.

In each cell 10, the conductive layers 13 and 14 are patterned to provide an electrode arrangement which is capable of providing independent driving of a rectangular array of pixels across the liquid crystal layer 19 by different respective drive signals. In particular, the electrode arrangement is provided as follows.

A first one of the conductive layers 13 or 14 (which may be either of the conductive layers 13 or 14) is patterned as shown in FIG. 4 and comprises a rectangular array of separate drive electrodes 31. The other, second one of the conductive layers 13 or 14 extends over the area opposite the entire array of drive electrodes 31 and thus acts as a common electrode.

The first one of the conductive layers 13 or 14 further comprises separate tracks 32 each connected to one of the drive electrodes 31. Each track 32 extends from its respective drive electrode 31 to a position outside the array of drive electrodes 31 where the track forms a terminal 33. The drive circuit 22 makes an electrical connection to each of the terminals 33 and a common connection to the second one of the conductive layers 13 or 14. Through this connection, the drive circuit 22 in use supplies a respective drive signal to each terminal 33 and thus the respective drive signals are supplied via the tracks 32 to the respective drive electrodes 31. In this manner, each drive electrode 31 independently receives its own drive signal and drives the area of the liquid crystal layer 19 adjacent to that drive electrode 31, which area of the liquid crystal layer 19 acts as a pixel. In this manner, an array of pixels is formed in the liquid crystal layer 19 adjacent to the array of drive electrodes 31. As each drive electrode 31 receives a drive signal independently, each of the pixels is directly addressable.

Such direct addressing of each pixel is advantageous for a number of reasons. The electro-optic performance of the liquid crystal is improved as compared to passive multiplexed addressing because each pixel can be addressed independently without affecting or influencing the neighbouring pixels. Also, direct addressing allows compensation of non-uniformity in the parameters of the cell over the area of the display device, for example variation in thickness of the liquid crystal layer due to the manufacturing process, or temperature variation across the display device. Each pixel can be driven with a drive signal adapted, for example by varying parameters such as voltage or pulse time to compensate those variations.

To accommodate the tracks 32 in the first one of the conductive layers 13 or 14, the drive electrodes 31 are arranged in lines (extending vertically in FIG. 4) with a gap 34 between each adjacent line of drive electrodes 31. The tracks 32 connected to a single line of drive electrodes 31 all extend along one of the gaps 34. All the tracks 32 from each drive electrode 31 in the line of drive electrodes 31 exit the array of drive electrodes 31 on the same side, that is lowermost in FIG. 4. As a result, all of the terminals 33 are formed on the same side of the display device 24. This has particular advantage when a plurality of identical display devices 24 are tiled to provide a larger image area because it reduces the gap needed between the individual display devices 24.

For clarity FIG. 4 illustrates the drive electrodes 31 and tracks 32 of only two lines of five pixels. The actual display device 24 may comprise any plural number of pixels in each dimension, typically 36 lines of 18 pixels or larger.

The drive circuit 22 will now be described with reference to FIG. 5.

The drive circuit 22 is formed by a CPU unit 35 mounted on a circuit board 36 which is a printed circuit board. The circuit board 36 receives power from a power supply unit 28 which is external to the display apparatus 1 and receives power from an external supply, typically a mains supply or line supply. The power supply unit 28 generates a 3-5V supply which the circuit board 36 supplies to the CPU unit 35 and a 50-65V supply which is used in an amplifier block 37 on the circuit board 36 to generate drive signals for the display device 24. As an alternative to the use of a power supply unit 28 external to the circuit board 36, the circuit board 36 may be arranged to receive power from a 24V supply by incorporating a low voltage regulator circuit to generate a 3-5V supply and a high voltage generator circuit to generate a 50-65V supply.

The drive circuit 22 also receives an image signal 29 representing an image. In general, the image signal 29 may represent a static image or a video image. The image signal 29 may derive from a source such as a personal computer. Typically the image signal 29 is digital LCD format running on LVDS bus. The CPU unit 35 generates drive signals for each of the pixels of each of the cells 10R, 10G and 10B in accordance with the image signal 29 supplied thereto. The drive signals generated by the CPU unit 35 are amplified by the amplifier block 37 and are supplied to the conductive layers 13 and 14 of each of the cells 10R, 10G and 10B to cause the display device 24 to display the image by switching the liquid crystal material of each pixel into a state having an appropriate reflectance.

The form of the drive signals generated by the drive circuit 22 is as follows.

In a typical image, some of the pixels will be in a full bright state, some in a grey level and some in a fully dark state. Thus it is necessary to drive the pixels in each cell 10R, 10G and 10B into a range of reflectances in accordance with the image signal 29. For different portions of the range of reflectances, the drive circuit 22 generates drive signals for respective pixel in accordance with two different schemes as shown schematically in FIG. 6 in which reflectance increases vertically.

In a first portion 41 of the range of reflectances of higher reflectance, the drive circuit 22 generates a drive signal in accordance with a static drive scheme to achieve a reflectance as shown by the grey scale 42.

In a second portion 43 of the range of reflectances of lower reflectance than the first portion, the drive circuit 22 generates a drive signal in accordance with a dynamic drive scheme to achieve a reflectance as shown by the grey scale 44.

The static drive scheme is used to drive pixels into a stable state, that is the planar state, the focal conic state or a mixed state having a reflectance between that of the planar and focal conic states. Thus the maximum reflectance of the first portion of the range is in the planar state, labelled as 100% full colour in FIG. 6, whereas the minimum reflectance of the first portion of the range is in the focal conic state, labelled as focal conic black in FIG. 6. As the static drive scheme drives the pixel in question into a stable state, use of the static drive scheme only consumes power to change image displayed. After the drive signal has been applied, the stable state is maintained and so the pixel continues to display the image without consuming power. Thus the power consumption is low for all pixels having a reflectance in the first portion of the range.

The dynamic drive scheme makes use of the unstable homeotropic state to drive pixels into a state having a lower reflectance than the focal conic state. In particular, pixels may be driven into the homeotropic state continuously to achieve a state of minimum reflectance, this being the minimum reflectance of the second portion of the range. To achieve higher reflectances in the second portion of the range, pixels are driven into the homeotropic state and planar state alternately.

One form of the drive signals in the static drive scheme is as follows.

In the static drive scheme, the drive signals are of a known form for driving cholesteric liquid crystal into a stable state with variable grey levels. This is a variant of the conventional drive scheme described first in W. Gruebel, U. Wolff and H. Kreuger, Molecular Crystals Liquid Crystals, 24, 103, 1973 and later in other documents.

The drive signal takes the form shown in FIG. 7 which is a graph of voltage over time. The drive signal having the waveform shown in FIG. 7 is supplied for each successive image (that is, in the case of the image signal 29 being a video signal, in each successive frame period of the video signal), in accordance with the value of the respective pixel.

The drive signal comprises a reset pulse waveform 50, followed by a relaxation period 51, followed by a selection pulse waveform 52.

The reset pulse waveform 50 is shaped to drive the pixel into the homeotropic state. In this example, the reset pulse waveform 50 consists of a single balanced DC pulse which may equally be considered as two DC pulses 53 of opposite polarity.

The relaxation period 51 causes the pixel to relax into the planar state. The reset pulse waveform releases quickly so that the relaxation is into the planar state, rather than the focal conic state. The planar state forms within a short time period typically 3 ms to 100 ms depending on liquid crystal materials and alignment layers used. Accordingly the relaxation period is longer than this.

The selection pulse waveform 52 drives the pixel into a stable state having the desired reflectance. To achieve the maximum reflectance, the selection pulse waveform 52 is omitted altogether so that the drive signal consists only of the reset pulse waveform 50, followed by the relaxation period 51 to leave the pixel in the planar state. To achieve lower reflectances, the selection pulse waveform 52 comprises an initial pulse 54 optionally followed by a tuning pulse 55. In this example, the initial pulse 54 and the tuning pulse 55 each consist of a single balanced DC pulse. Thus the initial pulse 54 may equally be considered as two DC pulses 56 of opposite polarity and the tuning pulse 55 may equally be considered as two DC pulses 57 of opposite polarity.

The amplitudes of the initial pulse 54 and the tuning pulse 55 are variable to drive the pixel into a stable state having a correspondingly variable reflectance. This may be understood by reference to FIG. 8 which shows the electro-optical curve of a typical liquid crystal material. In particular, FIG. 8 is a graph of the reflectance (in arbitrary units) of a liquid crystal initially in the planar state (that is at the end of the relaxation period 52) after application of a pulse of variable amplitude (that is the initial pulse 54), the reflectance being plotted against the amplitude of that pulse. Thus the amplitude of the initial pulse 54 is selected at a point on the curve of FIG. 8 between V1 and V2 or between V3 and V4 to provide the desired reflectance.

The slope of the curve between V1 and V2 or between V3 and V4 allows many grey level states to be achieved. For example, FIG. 9 is a graph of reflectance (arbitrary units) which may be achieved against the voltages of the initial pulse 54 of the selection pulse waveform for a liquid crystal material having the electro-optical curve of FIG. 8.

The tuning pulse 55 may be omitted so that the selection pulse waveform 52 comprises a single pulse, that is the initial pulse 54. If the tuning pulse 55 is included, the initial pulse 54 drives the pixel into an initial stable state and the tuning pulse 55 drives the pixel into a final stable state. The tuning pulse 55 preferably has a lower amplitude than the initial pulse 54. The advantage of using the tuning pulse 55 is that it can improve the resolution by allowing the pixel to reach a number of different final stable states between the initial stable states. This improves the static image quality.

In some implementations there is always a tuning pulse 55 regardless of the desired reflectance. In other implementations, the tuning pulse 55 is either (1) absent if the desired reflectance is equal to the reflectance of one of the initial stable states or (2) present if the desired reflectance is equal to the reflectance of one of the final stable states.

As an alternative to the amplitude of the selection pulse waveform 52 being variable, the duration of the initial pulse 54 and/or the tuning pulse 55 may be variable, as shown by the dotted lines in FIG. 7, to achieve a variable reflectance. This works in a similar manner to variation of the amplitude.

The actual amplitudes and durations of the reset pulse waveform 50 and the selection pulse waveform 52 vary in dependence on a number of parameters such as the actual liquid crystal material used, the configuration of the cell 10, for example the thickness of the liquid crystal layer, and other parameters such as temperature. As is routine in cholesteric liquid crystal display devices, these amplitudes and durations can be optimised experimentally for any particular display device 24. Typically, the reset pulse waveform 50 might have an amplitude of 50V to 60V and a duration of from 0.6 ms to 100 ms, more usually 50 ms to 100 ms. Typically the initial pulse 54 and/or the tuning pulse 55 might have an amplitude of from 10V to 20V and a duration of from 0.6 ms to 100 ms.

In the above example, the pulses 52, 54 and 55 are all balanced DC pulses. In general any of these pulses 52, 54 and 55 may alternatively be DC pulses or AC pulses. In general it is preferred that the pulses are DC balanced to limit electrolysis of the liquid crystal layer 19 which can degrade its properties over time. Such DC balancing may be achieved by the use of balanced DC pulses, AC pulses or else DC pulses which are of alternating polarity for successive displayed images.

Other drive scheme for driving the pixels into stable states having variable reflectances are possible and may alternatively be applied as the static drive scheme.

One form of the drive signals in the dynamic drive scheme is as follows.

The dynamic drive scheme operates on the same principle as the drive scheme disclosed in WO-2004/030335. In particular, the drive signals take the form shown in FIGS. 10A to 10C which are graphs of voltage over time. One of these drive signals is supplied in each of successive drive periods.

To drive the pixel into a state of minimum reflectance, the drives signal takes the form shown in FIG. 10A comprising a drive pulse 60 which drive the pixel into the homeotropic state for the entire drive period, that is continuously without allowing relaxation into the planar state.

To drive the pixel into a state of higher reflectance, the drive signal takes the form shown in FIG. 10B comprising a drive pulse 61 of duration Th which drives the pixel into the homeotropic state and a relaxation period 62 of duration Tp which allows the pixel to relax into the planar state. Thus the pixel is driven into the homeotropic state and the planar state alternately within the drive period. The durations Th and Tp are variable to vary the amounts of time spent by the pixel in the homeotropic and planar states. As a result of persistence of vision, the viewer perceives the pixel as having a reflectance which is the average of the reflectance over the entire drive period. Thus the reflectance perceived by the viewer varies as the durations Th and Tp vary. This allows the production of grey levels in the second portion of the range of reflectances.

In fact, the change in the reflectance over the drive period is quite complicated. At the end of the drive pulse 61, the liquid crystal material of the pixel starts to change back into the stable planar cholesteric state within this cycle and reflects some light. This relaxation is a complex process and proceeds via a metastable transient planar state that has about twice the pitch length (in fact the pitch of transient planar texture is equal to K33/K22×the pitch of final planar state where K33 is the liquid crystal bend elastic constant and K22 is the twist elastic constant) of the stable planar cholesteric phase (as explained for example in D-K Yang & Z-J Lu, SID Technical Digest page 351, 1995 and in J Anderson et al, SID 98 Technical Digest, XXIX page 806, 1998). Although this produces some non-linearity, it is nonetheless the case that the average reflectance increases with increase in the ratio of the amounts of time in the planar and homeotropic states, that is Tp/Th in this case.

The actual change in reflectance is difficult to model but can be plotted by experiment. For example, FIG. 11 is a graph of the reflectance (arbitrary units) achievable for different durations Th and Tp for a cell 10 of the same type as that to which FIGS. 8 and 9 apply. In FIG. 11, the horizontal axis is the duration Tp of the relaxation period 62 measured as a number of time slots. Each time slot has a length of approximately 0.3 ms in this example so the maximum reflectance in FIG. 11 is achieved when the duration Tp of the relaxation period 62 is approximately 4 ms. More points could be plotted if desired.

Furthermore, the selection of the durations Th and Tp is made so that the maximum value of the duration Tp of the relaxation period 62 provides the pixel with an average reflectance which is the maximum reflectance of the second portion of the predetermined range, that is equal to the reflectance of the focal conic state which is minimum reflectance of the first portion of the predetermined range. Again this is difficult to model but is easily determined by experiment in respect of the display device in question. For example, for a cell 10 of the type to which FIGS. 8 and 9 apply this might typically correspond to the duration Th of the drive pulse 61 being 9 ms. Thus it is possible for a continuous range of reflectances to be achieved by the static and dynamic drive schemes as shown for example in FIG. 12 which shows the graphs of FIGS. 9 and 11 overlapping each other.

In the case that the image signal 29 is a video signal, the drive period may be a frame period of the image signal 29. In this case, the frequency F_{H} at which the pixels are driven into the planar state is equal to the frame rate of the image signal 29. This is preferred to minimise the power consumption and the stress on the liquid crystal material of the pixel. However, the drive period may have other lengths relative to the frame period. For example there may be a plurality of drive periods in each frame period of the image signal 29. In this case, the frequency F_{H} at which the pixels are driven into the planar state is greater than the frame rate of the image signal 29.

In the case that the image signal 29 represents a static image the drive period is set by the drive circuit 22.

The drive period is sufficiently short that due to the persistence of vision the viewer perceives an average reflectance over the drive period, as discussed above. Typically, the rate might be at least 33 Hz corresponding to a drive period of 30 ms, or at least 50 Hz corresponding to a drive period of 20 ms. Typically, the rate might be at most 150 Hz corresponding to a drive period of 6 ms, or at most 100 Hz corresponding to a drive period of 10 ms. In the examples described below, the drive rate is 84 Hz corresponding to a drive period of 12 ms.

To facilitate digital implementation, the drive period is divided into a predetermined number of time slots and the drive pulse 61 (or plural drive pulses, if used) are applied in a variable number of the time slots. This means that the change in reflectance occurs in discrete steps and thus the length of the time slots is chosen to provide an appropriate resolution in the resultant grey scale.

The amplitude of the drive pulses 60 and 61, and the drive period, needed to drive the pixel into the homeotropic state in general vary in dependence on a number of parameters, in a similar manner to the parameters of the drive signal of the static drive scheme. The amplitude of the drive pulses 60 and 61 may be determined experimentally for a given display device 24 but the amplitude is typically in the range from 40V to 70V.

In FIGS. 10A to 10C, the drive pulses 60 and 61 are shown as unipolar pulses. For DC balancing, the drive pulses 60 and 61 have alternating polarity in successive drive periods. As an alternative to provide DC balancing, the drive pulses 60 and 61 may be AC pulses or balanced DC pulses.

The drive signals of FIGS. 10A to 10C are applied repeatedly in successive drive periods. Thus power is continuously consumed by pixels having a reflectance in the second portion of the predetermined range. However, in practice the overall power consumption of the display device is relatively low as typical images require only a fraction of the cell 10 to be in the second portion 43 of the range of reflectances, typically of the order of 10% to 15% although this is dependent on the nature of the image represented by the image signal. The rest of the image can be driven using a bistable mode with low power consumption.

The advantage of the use of the dynamic drive scheme in combination with the static drive scheme is to improve the contrast ratio and the colour gamut. Considering the static drive scheme, the focal conic state is the dark state (or transparent state) but this still scatters light typically having a reflectance of from 3% to 4%. As a result the contrast ratio of the liquid crystal layer 19 is typically from 10 to 15, and with a conventional multiplex addressing electrode arrangement this gives an overall contrast ratio for the cell 10 of from about 6 to 8. However, use of the dynamic drive scheme allows use of the homeotropic state as the dark state (or transparent state). As the homeotropic state has a very low reflectance, this improves the contrast ratio. For example, the contrast ratio of the liquid crystal layer 19 is typically 50 or above and the contrast ratio of the overall display device 24 having a fill factor of the drive electrodes 31 (i.e. the area of the drive electrodes as a proportion of the area of the display) of 95% is about 30.

The colour gamut is also improved as follows. In general in the cholesteric display device 24 consisting typically of three stacked cells, the colour of each pixel within a cell 10 is influenced by those pixels above and below it. For example if the lowest pixel has to be at its 100% colour then the pixels above it must be in a transparent state to show the lower pixel optimally. With a known static drive scheme, when the upper pixels are switched into the focal conic state which is largely transparent but not fully transparent, the lower pixels will show a colour that is a mixture of the 100% colour and some white light scattered from upper (or lower) layers. In other words the colour is less saturated than is ideal and the colour gamut is degraded. However, the use of the dynamic drive scheme allows the dark state to have a lower reflectance, hence improving the colour gamut and providing purer colours.

Various modifications to the drive scheme described above may be made. One possibility is for the dynamic drive scheme to be used to drive pixels to higher reflectances, either by increasing the boundary between the first and second portions of the predetermined range or by making the first and second portions of the predetermined range overlap. However this is not preferred as the dynamic drive scheme consumes more power than the static scheme.

Similarly operation is possible with a restricted range of reflectances, for example by the static drive scheme not using the planar state or the dynamic drive scheme not driving pixels continuously into the homeotropic state, but this is not preferred due to the reduction in the contrast ratio achievable.

For use of the display apparatus 1 in bright ambient light, the illuminating light may be ambient light for example daylight. For use of the display apparatus 1 in low ambient light, the illuminating light may be provided by the lights 3. The number of lights 3 may be varied depending on the size of the display device 24 and the brightness of an individual light 3. The illumination provided by the lights 3 will now be described.

The display apparatus 1 includes a power circuit 70 mounted inside the housing 2, or alternatively within the case of the lights 3 themselves. As shown in FIG. 13, the power circuit 70 is electrically connected to the light 3 and supplies power to the light 3. The power circuit 70 is controlled to supply power to the lights 3 in response a light sensor 72 detecting that the ambient light has fallen below a predetermined threshold and/or in response to a timer 73 indicating night-time.

The power circuit 70 has a power input 71 through which it receives power from an external AC power supply 74 such as a mains supply. The power input 71 may be a common input with the drive circuit 22. The power circuit 70 converts the form of the AC power received from the external AC power supply 74 in order to reduce or eliminate the perception of flicker on the image display on the display device 24 when driven in accordance with the dynamic drive scheme and illuminated by the lights 3. The present inventors have appreciated that such perception of flicker arises as follows.

By way of explanation, there will first be considered the case that AC power is supplied from the external AC power supply 74 without modification of the waveform of the power by the power circuit 70. This will be described with reference to FIGS. 14A to 14C which are graphs over time for the example case that the display device 24 is driven by an image signal 29 having a frame rate of 84 Hz, and that the drive circuit 22 produces drive signals using the dynamic drive scheme with a single drive period in each frame period of the image signal 29 so that the frequency F_{H} at which the pixels are driven into the planar state is equal to the frame rate of the image signal 29.

FIG. 14A shows the reflectance R of an individual pixel. As can be seen, the reflectance R is a square wave at the frequency F_{H} which in this case is 84 Hz. As the reflectance R of the pixel alternates in the drive period at a frequency above the flicker fusion threshold F_{T}, the variation in the reflectance R is not perceived by the viewer who instead perceives an average reflectance.

FIG. 14B is a graph of the illumination power I_{L} of the light output by the lights 3 to illuminate the display device 24. The illumination power I_{L} fluctuates with the instantaneous power of the power supply at twice the supply frequency F_{S} because the instantaneous power is proportional to the square of the instantaneous voltage of the power. In this example case, the supply frequency F_{S} is taken to be 50 Hz, so the illumination power I_{L} fluctuates at 100 Hz.

FIG. 14C is a graph of the reflected power I_{R} of the light reflected by the pixels of the display device 24. The reflected power I_{R} is equal to the product of the illumination power I_{L} and the reflectance R. In particular, light is only reflected while the pixels have a high reflectance R provided by the cholesteric liquid crystal material being driven into the planar state. Light is not reflected when the pixel has a low reflectance R provided by the cholesteric liquid crystal material being driven into the homeotropic state. This may be thought of as the pixel sampling the illuminating light. As a result, there is an interference effect which causes the reflected power I_{R} to vary at the interference frequency of |2F_{S}−F_{H}|. In the example case illustrated in FIGS. 14A to 14C where the supply frequency F_{S} is 50 Hz and the frequency F_{H} is 84 Hz, then the interference frequency |2F_{S}−F_{H}| is 17 Hz. This variation in the reflective power I_{R} is perceived by a viewer as flicker of the image displayed on the display device.

The power circuit 70 avoids this problem by modifying the form of the power supplied to the lights 3 in accordance with one of the two alternatives (a) and (b), as follows.

In alternative (a), the power circuit 70 is arranged to supply DC power. In such a case, the variation in the illumination power I_{L} as illustrated for example in FIG. 14B does not occur at all. Accordingly, there is no corresponding variation in the reflected power I_{R} as shown for example in FIG. 14C so the viewer does not perceive any flicker in an image displayed on the display device 24.

In the case of alternative (a), the lights 3 may each comprise one or more light-emitting diodes (LEDs) or may each comprise an incandescent lamp. At present, the use of LEDs as the lights 3 would suffer from the disadvantage of having a high cost, especially for a large display such as a billboard where the large size of the display device 24 would require a large number of LEDs due to the relatively low power of an individual LED. However, as time goes on it is expected that the cost of LEDs will reduce making their use more economically attractive.

In alternative (b), the power circuit 70 is arranged to supply AC power to the lights 3 at a supply frequency F_{S} in accordance with equation (1):

|2F_{S}−F_{H}|≧F_{T} (1)

where F_{T} is the flicker fusion threshold. The flicker fusion threshold F_{T} is a psychophysical threshold, being the threshold at which an intermittent light stimulus is perceived to be steady to a viewer. For present purposes, the flicker fusion threshold F_{T} may be taken to be 40 Hz, although the flicker-reduction effect may be improved by taking the flicker fusion threshold F_{T} to have a higher value for example 50 Hz or 100 Hz. By setting the supply frequency F_{S} in accordance with equation (1), there is a variation in the reflected power I_{R} of the reflected light, but this occurs at a frequency at which the perception of flicker by the viewer is reduced or removed altogether. Examples of this flicker-reduction effect are illustrated in FIGS. 15A to 15C and FIGS. 16A to 16C, which are each graphs of the same quantities as FIGS. 14A to 14C, respectively, but under different illumination conditions. Thus FIGS. 15A and 16A each illustrate the reflectance R of the pixels and are each identical to FIG. 14A.

FIG. 15B illustrates the illumination power I_{L} when the power circuit 70 supplies an AC power at a supply frequency F_{S} of 500 Hz with a waveform which is sinusoidal so that the frequency of the illuminating light is 1000 Hz. In this case, as shown in FIG. 15C the reflected power I_{R} of the light reflected from the pixels does undergo a variation at the interference frequency |2F_{S}−F_{H}| of 916 Hz, but this is well above the flicker fusion threshold F_{T} and is hence imperceptible to the viewer.

Similarly, FIG. 16B illustrates the illumination power I_{L} in the case that the power circuit 22 supplies AC power at a supply frequency F_{S} of 65 Hz having a waveform shaped as a square wave. In this case, as shown in FIG. 16C the reflected power I_{R} of the reflected light again undergoes a variation at an interference frequency |2F_{S}−F_{H}| of 46 Hz. Although this is only just above the flicker fusion threshold F_{T} the variation is not perceived by the viewer as a result of the square wave waveform of the AC power causing a reduction in the magnitude of the variation in the illumination power.

In both the cases illustrated in FIGS. 15C and 16C, the viewer perceives an intensity of light which is the average value of the reflected power I_{R} over the drive period.

The supply frequency F_{S} may be chosen to have any value in accordance with equation (1) to produce the effect of reducing flicker. However, in respect of the lights 3 being of certain types, an increased supply frequency can reduce the efficiency of the lights 3. To avoid this effect, the supply frequency F_{S} is selected to have a relatively low value whilst being in accordance with equation (1). For this reason, the example illustrated in FIG. 16 of the supply frequency F_{S} being 65 Hz may be preferable in respect of lights 3 of some types to the example shown in FIG. 15 where the supply frequency F_{S} is 500 Hz.

Advantageously in alternative (b), the power circuit 70 supplies AC power at a supply frequency F_{S} which is itself at or above the flicker fusion threshold. This also reduces the perception of flicker to the viewer. Firstly, the viewer does not perceive the lights 3 themselves as flickering. Any such flicker of the lights 3 would be distracting to the viewer even in the case that there was no flicker of the image displayed on the display device 24. Furthermore, when the drive circuit 22 drives the display device 24 in accordance with the static scheme so that pixels are driven into a stable state which is maintained until the image changes, this reduces or avoids the perception by the viewer of flicker in the image produced by those pixels.

To achieve such a high supply frequency F_{S}, equation (1) may be replaced by equation (2) which represents the case of equation (1) that (2F_{S}−F_{H}) has a positive value:

(2F_{S}−F_{H})≧F_{T} (2)

In equation (2), the frequency 2F_{S} of the illumination power I_{L} is greater than the flicker fusion threshold F_{T} by at least the frequency F_{H}.

However, within these constraints, the supply frequency F_{S} is kept as low as possible to reduce power consumption.

The waveform of the AC power supplied by the power circuit 22 is advantageously shaped as a square wave, as in the example of FIG. 16B. This has the advantage of reducing the magnitude in the variation of the illumination power I_{L} of the light output by the lights 3. This further reduces the perception of flicker by reducing the magnitude of the variation in the reflected power I_{R} of the light reflected from the pixels. Effectively, this means that the supply frequency F_{S} can be reduced to reduce power consumption.

In alternative (b), the lights 3 may advantageously comprise discharge lamps. One possibility is that the lights 3 comprise a halogen discharge lamp, but this suffers from the disadvantage that a halogen discharge lamp has a low efficiency, a short life time and a colour temperature that changes the colours of the images perceived on the display device 24 to appear to be of an orange or red colour. A better possibility is that the lights 3 comprise a metal-halide discharge lamp which do not suffer from these problems. Another possibility is that the lights 3 are fluorescent discharge lamps.

When the lights 3 comprise discharge lamps, the power circuit 22 is conveniently formed as an electronic ballast of a conventional type and construction. Electronic ballast are in themselves known for use with a discharge lamp. A discharge lamp creates an ion flow along a gas in a tube inside the lamp, for example between two filaments at each end of the tube. The ion flow causes light to be emitted by the gas. When an ion flow is created, a flow of current is created which increases non-linearly and would burn out the lamp if not choked. A discharge lamp may be provided with a ballast to choke such a current. The commonest type of ballast is a magnetic ballast which may be simply a high impedance coil. A known alternative is an electronic ballast. Some types of electronic ballast are operable to convert the frequency of the AC power received from the external AC power supply 74 to provide AC power to the lights 3 at a higher frequency and with a square wave waveform. The power circuit 70 may thus be such a known electronic ballast. Furthermore, electronic ballasts typically also provide AC power with a waveform shaped as a square wave which is also advantageous, as discussed above.

1. A display apparatus comprising:
a cholesteric liquid crystal display device having at least one cell comprising a layer of cholesteric liquid crystal material and an electrode arrangement capable of providing independent driving of a plurality of pixels across the layer of cholesteric liquid crystal material by respective drive signals to drive the pixels into states providing the pixels with respective reflectances;
a drive circuit arranged to generate drive signals to drive respective pixels into states providing the pixels with reflectances in accordance with an image signal, wherein in respect of at least part of a range of possible reflectances the drive signals have a waveform shaped to drive the respective pixels into the homeotropic state and the planar state alternately within successive drive periods for respective periods of time which are varied to provide an average reflectance as perceived by a viewer in accordance with the image signal,
a light source disposed to illuminate the display device when the light source is lit;
a power circuit connected to supply power to the light source, the power circuit being arranged to supply either:
a) DC power, or
b) AC power at a supply frequency F_{S} in accordance with the equation

|2F_{S}−F_{H}|≧F_{T}
where F_{H} is the frequency at which the pixels are driven into the planar state by the drive signals having a waveform shaped to drive the respective pixels into the homeotropic state and the planar state alternately and F_{T} is a threshold of at least 40 Hz.

2. A display apparatus according to claim 1, wherein the supply frequency F_{S} is in accordance with the equation
(2F_{S}−F_{H})≧F_{T}.

3. A display apparatus according to claim 1, wherein F_{T} is a threshold of 50 Hz.

4. A display apparatus according to claim 3, wherein F_{T} is a threshold of 100 Hz.

5. A display apparatus according to claim 1, wherein 2F_{S}≧F_{T}.

6. A display apparatus according to claim 1, wherein F_{H}≧33 Hz.

7. A display apparatus according to claim 1, wherein F_{H}<150 Hz.

8. A display apparatus according to claim 1, wherein the power circuit is arranged to supply AC power having a waveform shaped as a square wave.

9. A display apparatus according to claim 1, wherein the power circuit is arranged to supply AC power at a supply frequency F_{S} in accordance with the equation

|2F_{S}−F_{H}|≧F_{T}
where F_{H} is the frequency at which the pixels are driven into the planar state by the drive signals having a waveform shaped to drive the respective pixels into the homeotropic state and the planar state alternately and F_{T} is a threshold of at least 40 Hz.

10. A display apparatus according to claim 9, wherein the light source comprises at least one discharge lamp.

11. A display apparatus according to claim 10, wherein the light source comprises at least one metal-halide discharge lamp.

12. A display apparatus according to claim 10, wherein the light source comprises at least one fluorescent discharge lamp.

13. A display apparatus according to claim 10, wherein the power circuit comprises:
a power input for receiving an external AC power supply; and
an electronic ballast connected between the power input and the at least one discharge lamp, the electronic ballast being operable to convert the frequency of the external AC power supply received at the power input to provide said AC power at a supply frequency F_{S}.

14. A display apparatus according to claim 1, wherein the power circuit is arranged to supply DC power.

15. A display apparatus according to claim 14, wherein the light source comprises at least one light-emitting diode.

16. A display apparatus according to claim 1, wherein:
in respect of a first part of said range of possible reflectances, the drive signals have a waveform shaped to drive the pixel into a stable state; and
in respect of a second part of a range of possible reflectances which is lower than the first part, the drive signals have a waveform shaped to drive the respective pixels into the homeotropic state and the planar state alternately within successive drive periods, the periods of time during which respective pixels is driven into the homeotropic and planar states being varied to provide an average reflectance as perceived by a viewer in accordance with the input image signal.
